(19) United States
(12) Patent Application Publication
(10) Pub. No.: US 2012/0140292 A1
(43) Pub. Date: Jun. 7, 2012

(54) IDENTIFICATION AND/OR AUTHENTICATION OF ARTICLES BY MEANS OF THEIR SURFACE PROPERTIES

(75) Inventors: Markus Gerigk, Koln (DE); Andreas Bäcker, Wuppertal (DE); Thomas Birsztejn, Dormagen (DE); Ralf Imhäuser, Langenfeld (DE); Christian Roth, Leverkusen (DE); Walter Speth, Duren (DE); Simon Hoff, Koln (DE)

(73) Assignee: BAYER TECHNOLOGY SERVICES GMBH, Leverkusen (DE)

(21) Appl. No.: 13/320,648

(22) PCT Filed: Jun. 1, 2010
(86) PCT No.: PCT/EP2010/003326

§ 371 Date: Nov. 15, 2011

(30) Foreign Application Priority Data
Jun. 10, 2009 (DE) 102009025061.1
Jun. 10, 2009 (DE) 102009059054.4

(51) Int. Cl. H04N 1/40; H04N 1/04

(52) U.S. Cl. 358/448; 358/474

(57) ABSTRACT

The subject matter of the present invention is a method for identifying and/or authenticating objects with the aid of their surface nature. A further subject matter of the present invention is a sensor for scanning a surface.

The subject matter of the present invention is a method for identifying and/or authenticating objects with the aid of their surface nature. A further subject matter of the present invention is a sensor for scanning a surface.

The surface nature of objects plays an important role in the case of many technical products and methods, for example in mould construction and in the case of technical sliding or visible surfaces. With paper, the surface structure is an important quality feature, for example, in conjunction with printability.

Consequently, there is a multiplicity of measurement methods for determining the surface structure and for determining characteristic numbers for the surface nature. Measurement methods whose result is the topography of the surface are also denoted as direct methods. The indirect methods deliver characteristic numbers such as, for example, for roughness, without measuring the actual form of the surface itself An example of an indirect method is the method of Bekk for determining the roughness of a paper or cardboard sample by measuring an airstream which flows between a screen and the sample surface.

Tactile and optical methods can be distinguished in the case of the direct methods. With tactile methods, surfaces are scanned in pointwise fashion with mechanical probes. The probe deflection is measured electronically or optoelectronically. The result is a height signal recorded over the scan path, the so-called surface profile. The surface area of the topography is scanned by scanning surface profiles lying closely against one another. Similar methods, which operate without contact, are scanning electron microscopy or scanning atomic force microscopy (in the so-called non-contact mode).

An example of an optical method for determining topography is dynamic laser focusing (see, for example, Wochenblatt für Papierfabrikation, ISSN0043-7131, Volume 117, April 1989, No. 7; pages 271 to 274). In dynamic laser focusing, a laser is focused onto the surface with the aid of a lens. The lens can be moved perpendicular to the surface (in the z-direction) by means of a servomotor. A sensor determines the respective z-position of the lens in the focus position, and therefore delivers the topographic information while the sample is being moved horizontally under the lens by an xy-table.

Furthermore, topographic information of a surface can also be obtained, for example, with an acoustic or a chromatic near-field sensor, with an eddy current sensor or with a phase-type white light interferometer.

It is possible, in turn, to determine from the topographies determined characteristic numbers such as, for example, the mean roughness value Rₐ or the roughness depth R_{z} (see DIN EN ISO 4287:1998). Said characteristic numbers are defined on an individual measurement length, and are calculated as a rule as mean values from a plurality of individual measurement lengths. Five individual measurement lengths are standard for roughness parameters (DIN EN ISO 4288:1998).

Consequently, it is usual for the data volumes relating to surface topography that are recorded with direct methods to be compressed to a few characteristic numbers. The compression of the data volumes to a few characteristic numbers allows a classification of objects. However, the loss of individuality of the individual object is brought about by the compression of the data volumes to a few characteristic numbers, because only material classes, but not individual objects, can be inferred from the characteristic numbers.

However, the detection and recognition of objects plays an important role, for example in product tracking and in the context of instances of product counterfeit.

The automatic recognition of objects with the aid of bar codes, for example, is generally known in this context. Bar codes are applied to goods and/or packages, and permit the goods to be identified by machine in order to determine the price, for example. However, they do not offer any counterfeit protection because this can easily be copied and transferred onto other objects.

For security against forgery, identity cards, bank notes, products, etc. are nowadays provided with elements which can be imitated only with special knowledge and/or high technical complexity. Such elements are denoted as security elements here. The authenticity of an object can be checked on the basis of the presence of one or more security elements.

Optical security elements such as, for example, watermarks, special inks, guilloche patterns, microscripts and holograms are established worldwide. An overview of optical security elements, which are in particular but not exclusively suitable for document protection, is to be found in the following book: Rudolf L. van Renesse, Optical Document Security, Third Edition, Artech House Boston/London, 2005 (pages 63-259).

However, a majority of the security elements commercially available nowadays do not permit any individualization, that is to say many objects bear the same security element. The objects that bear the same security element cannot be distinguished with the aid of the security element.

However, it is frequently desired to be able to identify an individual object from a multiplicity of comparable objects in a unique and reliable fashion. The security element described in PCT/EP/2009/002809 enables individual objects to be individualized and therefore enables reliable and unique identification. However, it would be advantageous to be able to undertake to identify and/or authenticate an object even without aids such as security elements.

According to the prior art, methods of identification and authentication are also known in which no use is made of further features to be provided by the object itself

For example, WO2005/088533(A1) describes a method with the aid of which objects can be identified and authenticated by means of coherent radiation. In the method, coherent radiation is focused onto the surface of the object, and the surface is scanned. Photodetectors are used to detect the radiation reflected by the surface. The detected reflected radiation constitutes a characteristic reflection pattern which is unique to a multiplicity of different materials, and can be imitated only with great difficulty, since it is to be ascribed to random effects in the production and/or processing of the object. The characteristic reflection patterns relating to individual objects are stored in a database in order to be able to identify and/or authenticate each object at a later time. To this end, an object is measured anew, and the characteristic reflection patterns are compared with stored reference data.

It is stated in WO2005/088533(A1) that the detected reflection pattern is a mixture of speckle pattern and scattered radiation. It is a disadvantage of the method described in WO2005/088533(A1) that coherent radiation must be used. It is known to the person skilled in the art that sources of coherent radiation are much more expensive than incoherent radiation sources.

Furthermore, the method described in WO2005/088533(A1) is restricted to objects which are not damaged by irradiation and also reflect an adequate portion of the irradiated radiation again. The light-sensitive objects or objects with a high absorptivity for electromagnetic radiation cannot be detected and uniquely recognized later.

Starting from the prior art described, the object is therefore to provide a method with the aid of which a multiplicity of different objects can be identified and/or authenticated. The method being sought is to enable objects of the same kind to be distinguished. In this case, the method being sought is to manage without expensive aids such as, for example, individualized holograms or the like, with the aid of which objects of the same kind are individualized in accordance with the prior art. The method being sought should be cost effective, intuitive and easy to execute, be capable of flexible use and extension, yield reproducible and transferable results and be capable of production-line fabrication.

It has surprisingly been found that objects can be identified and authenticated with the aid of their surface nature. In this case, the surface of objects has individual features which are characteristic of the respective object. These features permit objects of the same kind to be distinguished.

Objects of the same kind are understood as those objects which appear the same but are not identical such as, for example, the individual sheets of a stack of paper, or individual mass-produced components.

The individual surface nature is surprisingly not restricted in this case to types of objects or materials, but is valid in principle for all objects. Thus even in the case of polished mirrors, where one would speak of a smooth surface without any noteworthy surface structure, in this case it is possible to make out an individual surface nature on the atomic scale.

It has surprisingly been found that the surface nature of many objects is so robust that it remains very largely unchanged even after a lengthy time, and so it can be used to identify and/or authenticate the respective object. Since the surface nature can be determined by a multiplicity of different measurement methods, various types of objects can be reliably identified and/or authenticated. Should an object be light-sensitive, the surface nature could be determined with a tactile method. Should an object be pressure-sensitive, the surface nature could be determined in a contactless fashion, for example by means of an optical method.

An object is understood as any solid body. The surface of the body separates it from the surrounding medium (mostly air).

Surface nature is understood as the three-dimensional structure of the surface of an object (topography). The terms surface nature and topography are used here synonymously. A surface profile is a profile which is produced by the (imaginary) section of a surface of an object by a prescribed plane (see, for example, DIN EN ISO 4287:1998, FIG. 2). Topography and surface profile are denoted together as surface structure.

Identification is understood as a process which serves to identify an object uniquely.

Authentication is understood to be the process of checking (verifying) an asserted identity. The authentication of objects is the ascertainment that the latter are authentic—that is to say that originals which have not been altered, copied and/or counterfeited are involved.

Method for Producing a Signature of an Object

A first object of the present invention is a method for producing a signature of an object.

The inventive method for producing a signature of an object comprises at least the following steps.
A1: Scanning a first region of a surface of the object, and receiving a scanning signal which represents at least a portion of the surface structure within this first region,
A2: Generating a signature from the scanning signal determined in step A1,
A3: Associating the signature with the object,
A4: Storing the signature in a form in which it can be available for later comparative purposes.

The signature is a storable information item relating to an object. It contains information about characteristic features of the object. The result here is the characteristic features from the unique surface nature of the respective object.

The scanning of a first region of a surface of an object in accordance with step A1 can be carried out with the aid of any method which can be used to determine a surface structure of an object, for example with the aid of a tactile or optical method. Here, commercial equipment which can be used is already on the market. It is preferred to use methods which detect a surface structure in a contactless fashion. Optical methods are used with particular preference.

The result of scanning is a scanning signal which represents the surface structure within the first region.

The scanning can be performed along a line. It is possible in this case to derive a surface profile from the scanning signal. It is likewise conceivable to undertake scanning in a meandering fashion or along a plurality of lines, preferably running parallel to one another. The parallel running lines preferably lie so close to one another that a surface topography can be derived from the scanning signals. This is shown by way of example in FIGS. 2, 3 and 5 of the following publication: Wochenblatt für Papierfabrikation, ISSN0043-7131, Volume 117, April 1989, No. 7; pages 271 to 274. Each individual surface profile which results from scanning along a single line is of itself unique. Neighbouring surface profiles do have similarities, however. Thus, continuous transitions from one surface profile to a neighbouring surface profile are to be identified. The individual lines along which scanning is performed should therefore lie so close next to one another that such a continuous transition can be identified. It is therefore possible to interpolate the regions between neighbouring surface profiles, and thus to approximate the entire topography from the individual scanned line regions.

The scanning signal which is picked up during scanning depends on the measurement method used. This may be explained using two examples.
I. It is possible to determine the surface structure by pointwise scanning of the surface with a mechanical probe. It is conceivable for the probe to be moved up to the surface until it touches the latter. Resistance occurs at the point where the probe touches the surface. It would be necessary to apply an increased force in order to move the probe further in the previously adopted direction (the surface obstructs the probe). This path length up to the occurrence of the resistance is registered, and the probe is moved back into its initial position. In the next step, the probe or the object is moved a little to the side (perpendicular to the direction in which the probe is moved up to the object), and the probe is moved up to the surface again. The path length is determined point for point in this way until a resistance occurs in each case. The scanning signal in this case comprises values for the path length as a function of the location. A surface structure (surface profile or topography) can be derived herefrom in a simple way.
II. It is also possible to scan the surface with the aid of a focused laser beam. The laser beam is focused onto the surface by means of a lens. The lens can be moved perpendicular to the surface (in the z-direction) by means of a servomotor. A sensor determines the respective z-position of the lens in a focused position, and therefore delivers the topographic information while the probe is being moved under the lens by an xy-table. The sensor is usually clocked, that is to say it picks up measurement signals with a constant frequency. The scanning signal in this case comprises the z-position of the lens as a function of time (measuring frequency). The xy-table executes a uniform movement at a constant speed, it always covers the same path in the time between the picking up of two measured values. There is thus a known correlation between the time and the location, such that the topography of the surface can be determined here, as well, in a simple way from the scanning signal.
   If measured values are picked up in clocked fashion with a constant frequency, and if a movement which is not uniform is undertaken between the scanning apparatus and object, it is also possible to use a mechanical encoder with which the temporal information can be transformed into spatial information. Such encoders are sufficiently known in particular for optical measurement methods. The method described in WO2005/088533(A1) also uses an encoder to correlate the temporal information with the spatial information (see there).

A signature is generated in step A2 of the inventive method from the scanning signal. According to the invention, the signature is used to identify and/or authenticate the object at a later instant. Thus, it is first necessary to generate a signature of each object which is to be identified and/or authenticated at a later instant. This process by means of which the signature of an object is determined for the first time is denoted here as initial detection or registration. If it is present, the signal of an object can be stored. At a later instant at which the object is detected anew, that is to say its signature is determined anew, the stored signature can be used as a reference for comparative purposes.

The signature is thus an information item which can be stored and processed by machine and can be obtained from the scanning signal and used for the purpose of identification and/or authentication. Storable is understood to mean that the signature can be taken up again at a later instant, for example for comparative purposes. Machine processing is understood to mean that the signature can be read by machine and can be subjected by machine to various computing and/or storing operations.

The signature includes information relating to features which uniquely characterize an object. The signature can be the scanning signal itself. The signature can also be a surface topography which has been derived from the scanning signal, that is to say an attribution of height information items of a surface region as a function of the respective surface locations. It is likewise conceivable for a signature to be a surface profile in accordance with the definition from DIN EN ISO 4287:1998.

As a rule, the signature is produced from the scanning signal by various mathematical methods such as filtering and/or background subtraction. These mathematical methods very largely eliminate random or systematic fluctuations resulting from individual measurements. In the case of paper type objects, it is possible, for example, for a corrugation resulting from the use of the object to occur in a surface profile. This can be disturbing in the case of identification and/or authentication, since it resulted only in the course of time and is therefore not included in the original signature. Such a corrugation can be eliminated (by calculation) from the scanning signal with the aid of suitable filters (see, for example, from DIN EN ISO 4287:1998).

It is likewise conceivable to subject the scanning signal or a filtered scanning signal to a mathematical transformation in order to generate a data record which is more suitable for the purpose of identifying and/or authenticating than the scanning signal or a filtered scanning signal itself. As an example of such a transformation, a Fourier transformation which produces a spatially independent representation of the scanning signal may be made.

Furthermore, it is conceivable to extract characteristics patterns from the scanning signal and to use these extracted data as signature (data reduction).

In step A3 of the inventive method for producing a signature, the signature is associated with the object. This association can be performed physically or virtually. In the case of a physical association, the signature can be printed onto the object, for example in the form of an optical code (bar code, matrix code, OCR text or the like), or is subscribed into the object. It is likewise conceivable to associate the object with a sticker which includes the stored signature. It is also conceivable to provide on the object an electronic data medium such as, for example, an RFID chip on which the signature is stored.

In the case of a virtual association, a unique number which is assigned to the respective object (ID number, batch number or the like), for example, is associated with the signature in a database. The signature can, for example, include this number in a so-called header (metadata at the start of a file). The association ensures that a clear and unique assignment exists between signature and object. The associated object can be inferred uniquely with the aid of the signature.

The signature is stored in a form in which it can be available for later comparative purposes in step A4 of the inventive method.

The storage can be performed, for example, on an electronic storage medium (semiconductor memory), an optical storage medium (for example compact disk), a magnetic storage medium (for example hard disk) or another medium for storing information. It is also conceivable to store the signature as optical code (bar code, matrix code) on a paper or on the object itself or as a hologram.

After the signature has been generated for the first time and stored, the respective object is registered and can be identified and/or authenticated at a later instant with the aid of its signature. The stored signature is also denoted here as reference signature.

Method for Identifying and/or Authenticating an Object

A second object of the present invention is a method for identifying and/or authenticating an object, comprising at least the following steps:
B1: Scanning a second region of a surface of the object, and receiving a scanning signal which represents at least a portion of the surface structure within this second region,
B2: Generating a signature from the scanning signal determined in step B1,
B3: Comparing the signature determined in step B2 with at least one reference signature,
B4: Generating a message about the identity and/or authenticity of the object as a function of the result of the comparison in step B3.

The inventive method for identifying and/or authenticating an object is subsequent to the inventive method for generating a signature.

What has been described for steps A1 and A2 applies respectively to steps B1 and B2, that is to say said steps take place very largely in the same way.

However, in step A1, a first region of a surface is mentioned, whereas in step B1 a second region of a surface is mentioned.

In order to permit the possibility of later identification and/or authentication, the region which is scanned during the identification and/or authentication is (the second region) must overlap at least partially with the region which has been scanned during the first detection (the first region). The larger the overlap, the higher the reliability with which an object can be identified and/or authenticated.

In a preferred embodiment of the inventive method, the first region (from step A1) and the second region (from step B1) are identical or at least largely identical. “Largely identical” is understood to mean that during later scanning of the surface an attempt is made to scan the same region which has also been scanned during the first detection. In the ideal case, the first and the second region are thus identical—but there can in practice be difficulties in refinding or exactly “hitting” the region of the first detection during a later detection. This is a question of positioning accuracy: how accurately is success achieved in positioning an object in relation to an apparatus for scanning the surface of the object such that a defined region of the surface can be scanned?

One possibility for reducing the requirements placed on positioning accuracy consists in selecting the region for scanning to be as large as possible. If the absolute accuracy of the positioning is, for example, ±1 mm in one direction, and if the region has an extent of 1 mm in this direction, the accuracy with which positioning can be performed is inadequate; there is the risk that the first region and the second region do not correspond at all. If the extent of the region in said direction is, however, 10 mm, a satisfactorily accurate positioning is very likely to be obtained; first region and second region deviate from one another by at most 10% in said direction.

However, an increase in the region is usually also accompanied by increased time outlay for scanning, and by a larger data volume for the scanning signal and the signature, and so the region cannot be selected to be relatively large.

A further possibility for reducing the requirements placed on positioning accuracy resides in the use of a so-called position indicator. A position indicator is understood as means which definitely characterize a region of a surface. A definitive characterization of a surface region is understood to mean that a region of the surface of an object is so accentuated and delimited in relation to other surface regions such that this surface region can be distinguished uniquely from all other surface regions, and that there is no surface region for which it is unclear whether it belongs to the characterized surface region or not. A position indicator can, for example, be a label which has a cutout and is connected to the object. Lying inside the cutout is the region which is to be scanned. If the region is scanned optically, the surface of the position indicator which is arranged around the cutout is preferably fashioned such that when it is being irradiated with electromagnetic radiation it exhibits behaviour different from that of the characterized surface region of the object. By way of example, if the object is a paper-like object with a high scattering power, the surface of the position indicator is fashioned to be specular, by way of example. In the case of tactile scanning of the surface region of the object, a label with a cutout as position indicator has the advantage that there are present around the surface region of the object edges which, in the case of tactile scanning, deliver a defined and effectively identifiable scanning signal which indicates where the surface region of the object begins and where it ends. Thus, a position indicator assists in “refinding” on the occasion of each later scan for the purpose of identifying and/or authenticating the region which was scanned during the first detection.

It has already been pointed out that it can be advantageous to fashion the region for scanning to be as small as possible. The smaller the region, the quicker scanning can be performed, the smaller are the data volumes which occur as scanning signal or signature, and the shorter is the computing time for comparison of a current signature with one or more reference signatures. There would thus be advantages were it required to scan the surface of the object only along a single line in order to generate a signature. However, it has already been explained that a reduction in the region is attended by more exacting requirements placed on the positioning accuracy. If the signature is a surface profile, that is to say the height information of a surface along a single line on the surface, it can be difficult to refind this one line during later detection.

It has surprisingly been found that this problem of rising demands placed on positioning accuracy whilst the region for scanning is being reduced can be solved by a virtue of the fact that the second region is smaller than the first region, and the second region lies within the first region.

A preferred embodiment of the inventive method for identification and/or authentication is characterized in that the second region is smaller than the first region and lies within this first region.

In order to fulfill an adequate positioning accuracy in step B1, the object must be positioned with reference to the scanning apparatus such that the scan region (second region) lies within a defined larger region (first region). The requirements placed on the positioning accuracy relax in accordance with increasing size of the first region and with decreasing size of the second region. Given a decrease in size of the second region, there is, of course, also a decrease in the data volume which is available for a comparison. In general, it is true that a statement on the identity and/or authentication of an object can be made with higher reliability, the larger the data volume which describes the identity of the respective object. Thus, what is required here is to find a sensible balance between simplified positioning and reliability when identifying and/or authenticating.

The signature which results from the scanning of the first, larger region and is stored as reference signature is appropriately larger than any signature which is generated during a later detection for the purpose of the identification and/or authentication during scanning of the second, smaller region. In step B3 of the inventive method for identification and/or authentication, it is consequently checked whether the current signature is present within the reference signature. How this would look in concrete terms could be that during the first detection a first region of the surface is scanned along a multiplicity of lines lying close to one another, and so the topography of this first region is determined and stored as reference signature. During identification and/or authentication, by way of example only the height profile along a single line (surface profile) which is located inside the first region is then recorded at a later point in time. In step B3, a test is made as to whether the surface topography of the first region has a corresponding surface profile at any position. It is not required in this case for the line along which scanning is performed during the identification and/or authentication also to be precisely one of the lines which was used for scanning during determination of the topography in the course of the first detection. As already stated above, during the determination of the topography the individual lines preferably lie so close to one another that a continuous transition can be identified between them. Consequently, it suffices for the individual line to lie inside the region of the multiplicity of lines. For corresponding reasons, it is also not required for the individual line to run exactly parallel to the multiplicity of lines. Owing to the continuous transition of the individual surface profiles which form the topography, known mathematical methods can be used to approximate the entire topography, and thus any desired surface profile within the topography can be calculated.

The preferred embodiment of the inventive method for identifying and/or authenticating an object in the case of which the second region is smaller than the first region can be used to advantage whenever there is enough time for the first detection, while the time for identification and/or authentication is limited in comparison herewith.

Works of art or jewelry may be named as examples. These are often handmade. By comparison with methods of machine production, more time is required for making by hand. Consequently, it is not important if the reference signature is generated by operating with a corresponding time outlay in which a large (first) region is scanned. The later identification and/or authentication can be performed more quickly as appropriate, for example for the purpose of routine checking with the aid of a smaller region.

It has surprisingly been found that the first and second regions can also be fashioned such that the second region is larger than the first region and encompasses this first region completely.

A further preferred embodiment of the inventive method for identifying and/or authenticating an object is therefore characterized in that the second region is larger than the first region and encompasses this first region completely.

Thus, during the first detection a reference signature is generated which results from a comparatively small scan region. During a later generation of a signature for the purpose of identification and/or authentication, a corresponding larger region is scanned, a signature is generated and it is examined in step B3 to what extent a reference signature is present in the current signature.

This preferred embodiment yields the same advantages with regard to positioning accuracy and reduced data volumes as in the case in which the second region lies within the first region (see above). Such an embodiment is advantageous whenever the first detection is time-critical by comparison with the later identification and/or authentication. This can be the case, for example, for production by machine, where the objects produced occur in large numbers and are transported at high speed on an assembly line. It is advantageous here to scan only a small region of the respective object in a very short time (step A1) in order to detect the respective object for the first time and to generate a corresponding reference signature. During later identification and/or authentication, the objects may occur in smaller numbers and there is more time to scan a larger region in step B1 in order to ensure that the first region (from step A1) is covered.

As already mentioned, in step B3 of the inventive method for identifying and/or authenticating an object the signature currently generated is compared with one or more reference signatures. Here, it is possible to distinguish between a so-called 1:1 match and the so-called 1:n match. In the case of the 1:1 match, only two signatures are compared. This is the case, for example, when there is already present information which relates to the supposed identity of the object and is still to be checked (authentication). It is, for example, conceivable for the object to bear a bar code which indicates the identity of the object. The supposed identity can be used to determine the reference signature which is assigned to the respective object. This is then compared with the currently generated signature.

If the identity is not known, and if the aim is to determine this with the aid of the currently generated signature, the currently generated signature is compared with a number n of reference signatures which come into consideration (1:n match) in order to find that reference signature which corresponds to the currently generated signature (identification).

The comparison itself can be performed with mathematical methods which are sufficiently known to the person skilled in the art. For example, it is possible to use methods of pattern matching in the case of which a search is made for similarities between data records (see, for example, Image Analysis and Processing: 8th International Conference, ICIAP '95, San Remo, Italy, Sep. 13-15, 1995. Proceedings (Lecture Notes in Computer Science), WO 2005088533(A1), WO2006016114(A1), C. Demant, B. Streicher-Abel, P. Waszkewitz, Industrielle Bildverarbeitung, Springer-Verlag, 1998, pages 133 ff, J. Rosenbaum, Barcode, Verlag Technik Berlin, 2000, pages 84 ff, U.S. Pat. No. 7,333,641 B2, DE10260642 A1, DE10260638 A1, EP1435586B1). Optical correlation methods are also conceivable.

The result of the comparison, for example the degree of correspondence between the compared signatures, is then output in step B4 to a user of an appropriate apparatus in the form of a visible or audible message (monitor, printer, loudspeaker, or the like).

Now that the inventive methods have been presented in general form, the aim is to go into more detail on particular embodiments without, however, restricting the invention thereto.

In the drawings:

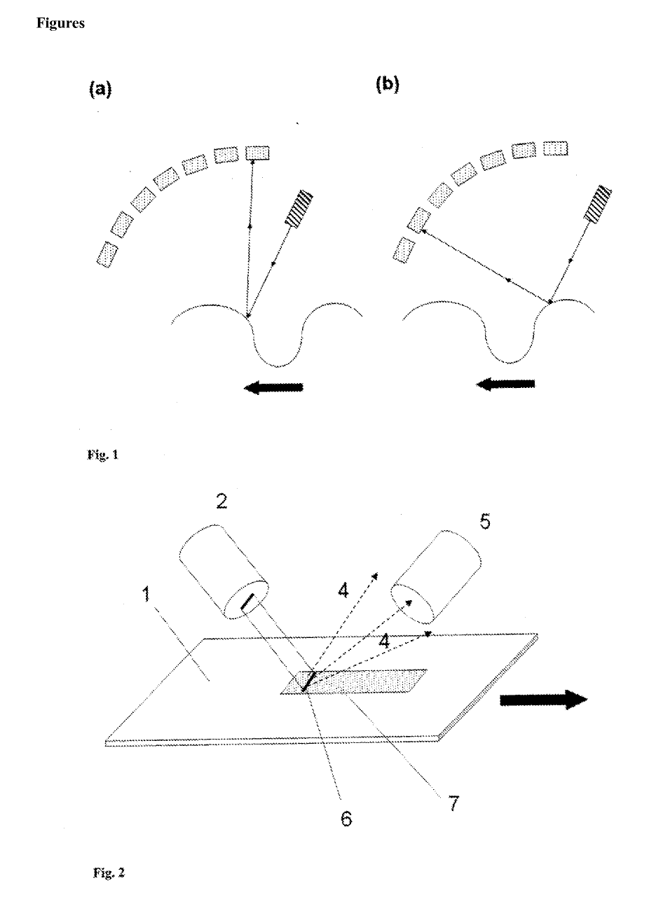

FIGS. 1(a), (b): show a diagrammatic illustration of the optical scanning of a surface,

FIG. 2: shows a diagrammatic illustration of the optical scanning of a surface, with a linear beam profile,

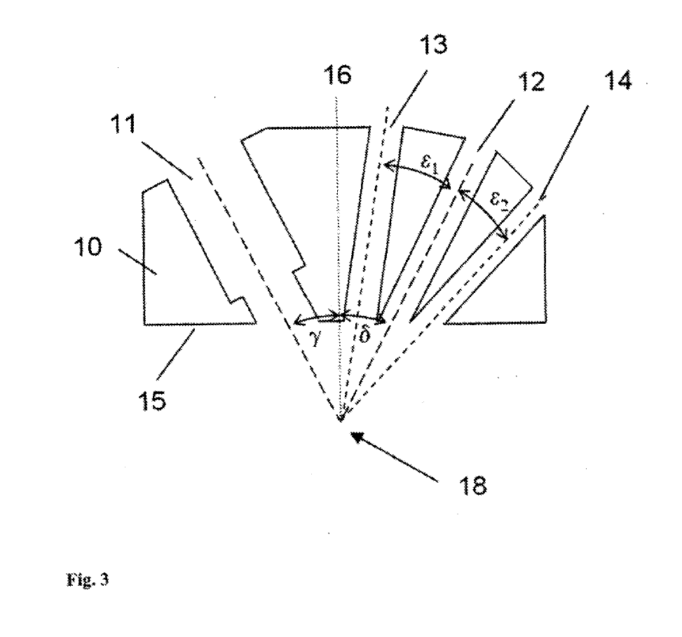

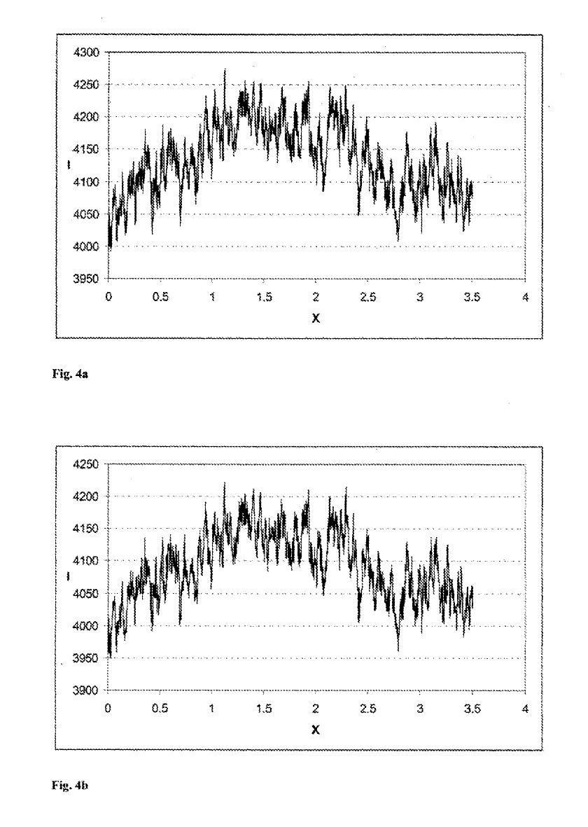

FIG. 3: shows a diagrammatic illustration of an inventive sensor for scanning surfaces, and

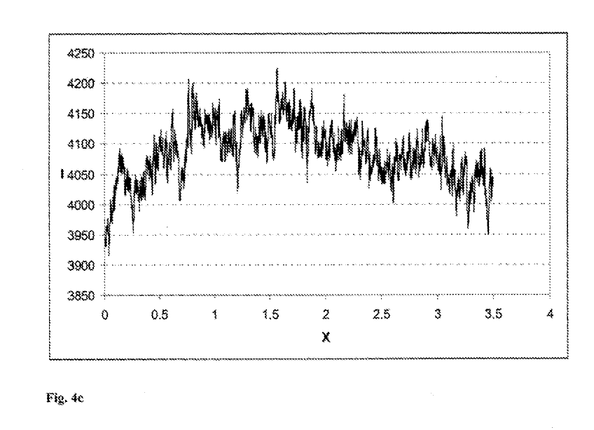

FIGS. 4a-4c: show scanning signals of a surface.

The scanning of a surface region is preferably performed optically, that is to say with the use of a source of electromagnetic radiation and of at least one detector for electromagnetic radiation (also denoted as photodetector). It is preferred to use as radiation source a source which can produce electromagnetic radiation of high intensity. For example, laser radiation is known to have a high power density, and it can be effectively focused, and so the dimensions of the focused laser beam can be kept appropriately small in the focal plane. The smaller the dimensions of the scanning beam in the focal plane, the higher the accuracy with which the surface can be scanned.

The cross-sectional profile of the scanning beam in the focal plane should be as far as possible the same for the scannings in accordance with steps A1 and B1, so that during the later comparison of signatures in accordance with step B3 there are no excessively large differences between the signatures as a consequence of different resolutions in the scanning. The cross-sectional profile is understood as the two-dimensional intensity distribution of the radiation in the focal plane.

FIG. 1 illustrates diagrammatically how the scanning of a surface region can be executed with the aid of a scanning beam.

The figure shows the surface 1 of an object, and an arrangement comprising a source for electromagnetic radiation 2 and a multiplicity of detectors 5 for electromagnetic radiation. The surface 1 is illustrated in a greatly enlarged fashion by comparison with the radiation source 2 and the detectors 5 for reasons of better clarity.

A scanning beam 3 can be transmitted by the radiation source onto the surface 1 of the object. The object is moved with reference to the arrangement composed of radiation source and detectors (marked by the thick black arrow). In this case, the scanning beam grazes the surface. The scanning beam is reflected by the surface in accordance with the law of reflection. Depending on the curvature of the surface, the reflected radiation 4 passes into one of the detectors. In this way, the surface can be scanned and a scanning signal can be picked up. The surface structure can be determined from the scanning signal.

Instead of using the multiplicity of individual detectors, it is also conceivable to use an appropriately large detector (CCD, CMOS camera). In contrast with dynamic laser focusing (see above), there is no need to use a mechanically adjustable lens in the method described here. Surprisingly, it has been found that it suffices when the scanning beam is focused onto a point on the surface. Movement between the object and the arrangement composed of radiation source and detectors is then performed with a constant spacing between object and arrangement. Because of the height differences on the surface, not all points at which the scanning beam strikes the surface lie exactly in the focal plane. Nevertheless, a topography can surprisingly be derived from the scanning signal. It is therefore preferred to use radiation sources which have a large focal depth.

The irradiation (scanning) of the surface can be performed at any desired angle from approximately 0° (if reflection still impinges) to 90° with reference to the mean surface plane. The detection of the reflected radiation can likewise be performed at any desired angle from approximately 0° to 90° with reference to the mean surface plane.

The use of an apparatus in accordance with FIG. 1 has the advantage that, by contrast with the known apparatuses for dynamic laser focusing, there is no need for any mechanically adjustable lenses. Consequently, an apparatus in accordance with FIG. 1 is less complex and therefore more cost effective and less prone to error. In addition, with an apparatus in accordance with FIG. 1 scanning can be performed much more quickly than with an apparatus for dynamic laser focusing, since there is no time incurred for mechanical readjustment of a lens.

Furthermore, it has surprisingly been found that there is no need to cover the entire surface structure during scanning in order to determine a signature. The surface nature of many objects is so rich in characteristic features that a fraction thereof suffices for identification and/or authentication. This means that in the arrangement in FIG. 1 a single detector suffices instead of the multiplicity of them. This one detector then no longer detects every curve of the surface, but only the signals which are transmitted by the surface in the direction of the detector. Surprisingly, however, the scanning signal detected by means of the detector is sufficient in order to generate a signature for the purpose of identification and/or authentication.

The radiation transmitted onto the surface is preferably incoherent, in order to exclude disturbing interference phenomena. It is known that coherent radiation which falls onto a rough surface produces speckled patterns. The speckled patterns are a function, inter alia, of the angle of irradiation and the space between radiation source and surface. Consequently, the speckled patterns can usually be reproduced only with difficulty. The speckled patterns are superimposed on the reproducible scanning signals, which are to be ascribed to the direct surface structure, and lead to a reduction in the signal-to-noise ratio.

Although it is true that laser beams have high intensity and can be focused very effectively, they are nevertheless coherent and lead to the undesired speckled patterns.

Consequently, a so-called speckle-reduced laser or a non-coherent radiation source such as, for example, an LED (LED=light-emitting diode) is preferably used as radiation source. Methods for reducing speckle phenomena in the case of coherent radiation are known to the person skilled in the art (see, for example, DE102004062418B4). Particular preference is accorded to the use of a so-called high power LED. It is also conceivable to use LED arrays, that is to say an arrangement of a plurality of LEDs.

In a preferred embodiment, scanning is undertaken only along a line in step A1 and/or in step B1. It is particularly preferred to undertake scanning only along a line both in step A1 and in step B1. This means that in the case of the use of a scanning beam in accordance with FIG. 1 said scanning beam is guided only once in a direction (along a single line) over the surface of an object in order to take up a scanning signal. Scanning can be performed substantially more quickly along a single line than along a number of lines arranged, for example, parallel to one another. The time outlay is minimal when scanning along a single line is performed both in step A1 and in step B1.

As already explained above, however, with decreasing size of the scan region it becomes increasingly difficult during later scanning to refind the region which has been detected during the first scan. According to the invention, this problem is solved by virtue of the fact that a linear beam profile is used for scanning. Specifically, it has surprisingly been found that a scanning signal and a signature for the purpose of identifying and/or authenticating an object can be determined even when the beam profile is expanded transverse to the direction of movement. This is illustrated diagrammatically in FIG. 2. A region 7 of a surface 1 of an object is irradiated with the aid of a source of electromagnetic radiation 2. A portion of the reflected radiation 4 is captured with the aid of a detector in order to take up a scanning signal. The object is moved with reference to the arrangement composed of radiation source and detector (represented by the thick black arrow). Present in the surface plane is a linear beam profile whose longer extent lies transverse to the direction of movement.

The problem of positioning is solved by expanding the beam profile in the direction transverse to the direction of movement. Instead of a thin line (with a width which corresponds to the extent of the punctiform beam profile), it is a wide region (with a width which corresponds to the longer extent of the linear beam profile) that is scanned. This wide region can correspondingly be refound more easily in later scanning.

The scanning with a linear beam profile in accordance with FIG. 2 corresponds, virtually, to averaging over a multiplicity of scanning signals which result from scanning with a punctiform beam profile along a multiplicity of lines lying close to one another and running in parallel. It is surprising that it is also possible to generate from this averaging over a wide region a signature with which an object can be identified and/or authenticated.

A linear beam profile is defined as follows here: the intensity is usually highest at the centre of the cross section of the radiation, and decreases outward. The intensity can decrease uniformly in all directions—a round cross sectional profile being present in this case. In all other cases, there is at least one direction in which the intensity gradient is greatest, and at least one direction in which the intensity gradient is smallest. What is understood below as the beam width is that distance from the centre of the cross sectional profile in the direction of the smallest intensity gradient at which the intensity has fallen to half its value at the centre. Furthermore, what is understood as being the beam thickness is that distance from the centre of the cross sectional profile in the direction of the highest intensity gradient at which the intensity has fallen to half its value at the centre. A linear beam profile denotes a beam profile for which the beam width is greater by a factor of more than 10 than the beam thickness. The beam width is preferably greater by a factor of more than 50 than the beam thickness, with particular preference by a factor of more than 100, and with very particular preference by a factor of more than 150.

The beam thickness is preferably in the range of the mean groove width of the surface present (see DIN EN ISO 4287:1998 for the definition of mean groove width).

The following beam thicknesses and beam widths have proved to be suitable for a multiplicity of objects, in particular for objects made from paper:
Beam widths in the range of 2 mm to 7 mm, preferably in the range of 3 mm to 6.5 mm, with particular preference in the range of 4 mm to 6 mm, and with very particular preference in the range of 4.5 mm to 5.5 mm.
Beam thicknesses in the range of 5 μm to 35 μm, preferably in the range of 10 μm to 30 μm, with particular preference in the range of 15 μm to 30 μm, with very particular preference in the range of 20 μm to 27 μm.

It is known to the person skilled in the art of optics how an appropriate beam profile can be produced by means of optical elements. Optical elements serve the purpose of beam shaping and focusing. Lenses, diaphragms, diffractive optical elements and the like, in particular, are denoted as optical elements.

The signal-to-noise ratio increases with decreasing size of the cross sectional profile of the scanning beam at the focal point, since the intensity is distributed over a smaller area. It has been found empirically that it becomes increasingly more difficult to attain reproducible signals with decreasing size of the cross sectional profile at the focal point. It would seem this is because the surface of the object to be authenticated can no longer be positioned with sufficient accuracy in relation to the cross sectional profile, which is becoming smaller. It would appear to be increasingly more difficult to hit the region with sufficient accuracy in the case of a renewed authentication.

It has surprisingly been found that the abovenamed ranges for the beam thickness and the beam width are very well suited, on the one hand, for attaining the accurate positioning sufficient for reproducibility and, on the other hand, for attaining a signal-to-noise ratio sufficient for authentication with satisfactory accuracy.

During scanning, the scanning apparatus and the object whose surface is to be scanned are moved at a constant spacing from one another. The beam width lies transverse to the direction of movement when use is made of a linear beam profile for scanning a surface region. The angle between the direction of movement and the direction of the beam width is preferably between 10° and 90°, with particular preference between 45° and 90°, with very particular preference between 70° and 90°.

Both a movement of the scanning apparatus in relation to the object, and a movement of the object in relation to the scanning apparatus are conceivable.

The movement can be performed continuously at constant speed, in an accelerated or decelerated fashion, or discontinuously, that is to say in stepwise fashion, for example. The movement is preferably performed at constant speed.

When use is made of a scanning beam for scanning a surface in accordance with FIG. 1 or 2 the radiation intensity impinging on at least one detector is detected as a function of time. It is usual for measurement signals to be detected and updated at a constant measuring frequency. If the relative movement between surface and detector is performed at constant speed, the time between two consecutively picked up measurement signals corresponds to a defined and constant path length. In this case, it is possible straightaway to transform the measurement signals detected as a function of time into a function of location. Given the occurrence of fluctuations in speed, use is preferably made of a mechanical encoder which is known to the person skilled in the art of signaling.

Preferred scanning of the surface with a linear beam profile for to a third object of the present invention, a sensor which can advantageously be used for scanning:

### Sensor for Scanning a Surface

A third object of the present invention is a sensor for scanning a surface of an object.

The inventive sensor comprises at least p1 a source for electromagnetic radiation which is arranged such that electromagnetic radiation can be transmitted onto the object at an angle α with reference to the surface normal to the object,
at least one photodetector for picking up reflected radiation, which is arranged such that the radiation reflected by the object at an angle β with reference to the surface normal to the object is detected.

It is conceivable for the angles α and β to be of equal magnitude. It is likewise conceivable for the angles α and β to be of different magnitudes. The absolute values of the angles α and β are preferably equal (|α|=|β|).

The absolute values of the angles α and β lie in the range of 5° to 90°, preferably in the range of 20° to 80°, with particular preference in the range of 30° to 70°, with very particular preference in the range of 40° to 60°.

In principle all sources for electromagnetic radiation that emit radiation which is at least partially reflected by the surface of the object to be scanned can be used as source for electromagnetic radiation in the inventive sensor. LEDs or (preferably speckle-reduced) laser diodes are preferred with reference to a compact and cost effective design of the inventive sensor. It is preferred to use radiation source which emit monochromatic or largely monochromatic radiation visible to humans; use is made with particular preference of a radiation source having a wavelength of between 600 nm and 780 nm.

It is preferred to use 1 to 6 photodetectors in the inventive sensor, 1 to 3 photodetectors preferably being used.

In principle, all electronic components which convert electromagnetic radiation into an electric signal can be used as photodetectors in the inventive sensor. Photodiodes or phototransistors are preferred with regard to a compact and cost effective design of the inventive sensor. Photodiodes are semiconductor diodes which convert into an electric current the electromagnetic radiation at a p-n junction or pin junction by the internal photoeffect. A phototransistor is a bipolar transistor with a pnp or npn layer sequence whose p-n junction, of the base-collector-depletion layer is accessible to electromagnetic radiation. It resembles a photodiode with a connected amplifier transistor.

The inventive sensor has optical elements which produce a linear beam profile.

The linear beam profile of the inventive sensor is characterized in that the beam width is larger by a multiple than the beam thickness. The beam width is preferably at least 50 times the beam thickness, with particular preference being at least 100 times and, with very particular preference, at least 150 times.

The beam width is in the range of 2 mm to 7 mm, preferably in the range of 3 mm to 6.5 mm, with particular preference in the range of 4 mm to 6 mm, and with very particular preference in the range of 4.5 mm to 5.5 mm

The beam thickness is in the range of 5 μm to 35 μm, preferably in the range of 10 μm to 30 μm, with particular preference in the range of 15 μm to 30 μm, with very particular preference in the range of 20 μm to 27 μm.

The inventive sensor is characterized in that the beam width lies transverse to the direction in which the inventive sensor is guided for scanning over the surface of an object.

The inventive sensor optionally has means for connecting a plurality of sensors or for connecting a sensor to a holder.

Two or more sensors can be interconnected in a prescribed way with the aid of these means. The connection of two or more sensors is performed reversibly, that is to say it can be undone.

The connecting means can also be used for the purpose of fitting the inventive sensor on a holder.

FIG. 3 shows by way of example a preferred embodiment of an inventive sensor without radiation source and photodetectors, in cross section from the side. The sensor comprises a block 10 with a designated outer surface 15. This designated outer surface—termed outer surface for short below—is directed during scanning onto the surface of the corresponding object.

The block 10 serves to hold all the optical components of the inventive sensor. It has at least two leadthroughs 11, 12 which run up to one another in the direction of the designated outer surface.

The first leadthrough 11 runs at an angle γ with reference to the normal 16 to the outer surface (outer surface normal, for short) and serves to hold the source for electromagnetic radiation.

A second leadthrough 12 runs at an angle δ with reference to the outer surface normal 16 and serves to hold a photodetector.

The absolute values of the angles γ and δ are preferably equal.

The absolute values of the angles γ and δ lie in the range of 5° to 90°, preferably in the range of 20° to 80°, with particular preference in the range of 30° to 70°, with very particular preference in the range of 40° to 60°.

In a preferred embodiment of the inventive sensor, one or two further leadthroughs 13, 14 are present and serve to hold one or two further photodetectors. These are arranged at an angle ε₁ and/or ε₂ to the second leadthrough 12. The size of the angles ε₁ and/or ε₂ is 1° to 20°, preferably 5° to 15°.

It is preferred for all the leadthroughs to lie in one plane, in order to enable a compact design of the sensor.

The use of a block with two to four leadthroughs for holding a radiation source and one or a plurality of photodetectors offers the advantage that the optical components can be arranged easily and yet in a defined way in relation to one another. It is preferred for there to be a stop in the leadthrough for the radiation source. The radiation source of the sensor is pushed into the leadthrough against this stop such that it occupies a prescribed fixed position with reference to the block and the photodetectors. If the radiation source has optical elements already connected thereto and intended for beam shaping and focusing, which is usual, for example, with many radiation sources commercially available today, the focal point of the radiation source is fixed uniquely at the same time by the fixing of the radiation source. The further leadthroughs for holding photodetectors can likewise be provided with a stop, the position of the photodetectors requiring to be less accurate than the position of the radiation source.

The block can be fabricated in a simple way, for example by means of injection moulding processes from plastic in one or two pieces. Injection moulding processes can be used to produce components with high accuracy in a large number of items and in a short time. This enables a cost effective mass production of sufficiently precise components. The leadthroughs can already be provided in the injection mould, or be introduced into the block subsequently by means of bores, for example. It is preferred for all the components of the block to be fabricated already in one step using the injection moulding process. It is likewise conceivable to mill the block, for example from aluminium or plastic, and to implement the leadthroughs by means of bores, for example. Further methods known to the person skilled in the art for fabricating a block with defined leadthroughs are conceivable.

The sensor can have a housing into which the block is introduced. It is preferred to introduce further components into the housing of the sensor, for example the control electronics for the radiation source, signal conditioning electronics, complete evaluation electronics and the like. It is preferred for the housing also to serve to anchor a connecting cable with the aid of which the inventive sensor can be connected to a control unit and/or a data acquisition unit for controlling the sensor and/or for detecting and further processing the characteristic reflection patterns.

The sensor can optionally have a window which is fitted in front of, behind or in the outer surface and protects the optical components against damage and contamination. The window preferably forms the outer surface of the sensor. The window is at least partially transparent at least for the wavelength of the radiation source used.

The inventive sensor in FIG. 3 is characterized, furthermore, in that the central axes of the leadthroughs intercept at a point 18 which lies outside the block. It has surprisingly been found that it is advantageous for the inventive identification and/or authentification, if the point of intersection of the central axes is at the same time the focal point of the radiation source and lies at a distance of 2 to 10 mm from the outer surface.

In order to scan the surface of an object, the inventive sensor is guided appropriately at a distance over this object such that the focal point and point of intersection of the central axes lies on the surface of the object.

Given said distance range of 2 to 10 mm, the surface of an object which is to be scanned can be positioned in relation to the radiation source and the photodetectors in a simple and sufficiently accurate fashion. With an increasing spacing between sensor and object, the angle of the sensor in relation to the surface of the object must be met with increasing accuracy in order to be able to detect a prescribed region of the surface, and so the requirements placed on the positioning become stricter.

Furthermore, the radiation intensity decreases with increasing distance from the radiation source and so, given an increasing spacing between sensor and object, it would be necessary to compensate the correspondingly reduced radiation intensity arriving at the object by means of a higher power of the radiation source.

The inventive sensor can be fabricated cost effectively on an industrial scale in mass production, has a compact design, can be handled intuitively and easily, can be used flexibly and can be expanded and delivers reproducible and transferable results.

FIGS. 4a, 4b and 4c show scanning signals which result from the scanning of an object with a linear beam profile. The scanning signal was respectively picked up with a sensor in accordance with FIG. 3. The ordinate respectively shows the voltage signal 1 (in arbitrary units) of the photo detector used, which is proportional to the intensity of the incident radiation. The path X in centimetres covered during scanning along a single line is plotted on the abscissa. Use was made in all cases of a single photo detector in the second leadthrough (12). The scanned object was a composite material consisting of the special paper 7110 from 3M (3M 7110 Litho paper, white) and a protective foil applied by lamination, PET Overlam RP35 from UPM Raflatac. Use was made as radiation source of a speckle-reduced laser diode (Flexpoint line module FP-HOM-SLD, Laser Components GmbH). The beam profile was linear, with a beam width of 5 mm and a beam thickness of 25 μm

The same range was scanned in the case of FIGS. 4a and 4b. The signals are very similar. In the case of FIG. 4c, a range other than in the cases of FIGS. 4a and 4b was scanned. The signal of FIG. 4c is unambiguously different from the signals of FIGS. 4a and 4b. A comparison of the signals from FIGS. 4a and 4b yielded a correlation coefficient of 0.98, whereas the comparison of the signals from FIGS. 4a and 4c returned a correlation coefficient of 0.6. The scanning signals are still capable of being very well reproduced even after a relatively long time.

The scanning signals in FIGS. 4a, 4b and 4c exhibit a multiplicity of characteristic features which can be used to generate a signature for the purpose of identification and/or authentication. It is therefore possible to distinguish various objects, as well as to re-identify identical objects later.

An analogous experiment using a high power LED array from Blau Optoelektronik GmbH (FP-65/0.5LF-LED, beam width 10 mm, beam thickness 60 μm) returned a similar result, the signal-to-noise ratio being lower.

### REFERENCE NUMERALS

1 Surface

2 Source for electromagnetic radiation

3 Scanning beam

4 Reflected beam

5 Photodetector

6 Linear beam profile

7 Scanned region

10 Block

11 First leadthrough for holding a radiation source

12 Second leadthrough for holding a photodetector

13 Further leadthrough for holding a photodetector

14 Further leadthrough for holding a photodetector

15 Outer surface

16 Outer surface normal

18 Focal point

1. A method for producing a signature of an object, comprising the following steps :
(A1) scanning a first region of a surface of the object, and receiving a scanning signal which represents at least a portion of the surface structure within this the first region,
(A2) generating a signature from the scanning signal determined in step A1,
(A3) associating the signature with the object,
(A4) storing the signature in a form in which it can be available for later comparative purposes.

2. A method for identifying and/or authenticating an object, comprising the following steps:
(B1) scanning a second region of a surface of the object, and receiving a scanning signal which represents at least a portion of the surface structure within this second region,
(B2) generating a signature from the scanning signal determined in step B1,
(B3) comparing the signature determined in step B2 with at least one reference signature,
(B4) generating a message about the identity and/or authenticity of the object as a function of the result of the comparison in step B3.

3. The method according to claim 15, wherein the second region is smaller than the first region and lies within this first region.

4. A method according to claim 15, wherein the second region is larger than the first region, and encompasses this first region completely.

5. A method according to claim 15, wherein the second region is substantially identical to the first region.

6. A method according to claim 15, wherein the scanning is performed optically with incoherent radiation.

7. A method according to claim 15, wherein, for the purpose of scanning, the object and an apparatus for scanning the object are moved at a constant spacing from one another, and the scanning is performed along a single line.

8. A method according to claim 7, wherein the scanning is performed with a linear beam profile whose longer extent lies transverse to the direction of movement.

9. The method according to claim 8, wherein the beam width of the linear beam profile is larger than the beam thickness by a factor of more than 50.

10. The method according to claim 7, wherein the beam thickness of the linear beam profile is in the range of the mean groove width of the surface present.

11. A sensor for scanning a surface, comprising at least
a block with an outer surface, a first leadthrough, which runs up to the outer surface at an angle γ with reference to the normal to the outer surface, and a second leadthrough, which runs up to the outer surface at an angle δ with reference to the normal to the outer surface, the absolute values of the angles γ and δ being equal,
a radiation source which is arranged in the first leadthrough and can transmit a scanning beam in the direction of the outer surface,
optical elements for forming a linear beam profile,
a photodetector which is arranged in the second leadthrough and aligned in the direction of the outer surface.

12. The sensor according to claim 11, wherein the beam width lies in the range of 3 mm to 6.5 mm, and the beam thickness lies in the range of 10 μm to 30 μm.

13. The sensor according to claim 11, wherein the absolute values of the angles γ and δ lie in the range of 5° to 90°.

14. The sensor according to claim 11, further comprising two further leadthroughs for holding photodetectors, which are arranged at an angle of ε₁ and ε₂, respectively, to the second leadthrough, the size of the angles ε₁ and ε₂ being 1° to 20°.

15. A method for producing a signature of an object, comprising the steps of:
(A1) scanning a first region of a surface of the object, and receiving a scanning signal which represents at least a portion of the surface structure within the first region,
(A2) generating a signature from the scanning signal determined in step (A1),
(A3) associating the signature with the object,
(A4) storing the signature in a form in which it can be available for later comparative purposes, and identifying and/or authenticating the object, comprising the steps of:
(B1) scanning a second region of a surface of the object, and receiving a scanning signal which represents at least a portion of the surface structure within this second region,
(B2) generating a signature from the scanning signal determined in step B1,
(B3) comparing the signature determined in step B2 with at least one reference signature,
(B4) generating a message about the identity and/or authenticity of the object as a function of the result of the comparison in step B3.

16. The sensor according to claim 11, wherein the beam width lies in the range of 3 mm to 6. 5 mm, preferably in the range of 4 mm to 6 mm, with particular preference in the range of 4.5 mm to 5.5 mm, and the beam thickness lies in the range of 10 μm to 30 μm, preferably in the range of 15 μm to 30 μm, with particular preference in the range of 20 μm to 27 μm.

17. The sensor according to claim 11, wherein the beam width lies in the range of 4 mm to 6 mm, and the beam thickness lies in the range of 15 μm to 30 μm.

18. The sensor according to claim 11, wherein the beam width lies in the range of 4.5 mm to 5.5 mm, and the beam thickness lies in the range of 20 μm to 27 μm.

19. The sensor according to claim 11, wherein the absolute values of the angles γ and δ lie in the range of 20° to 80°.

20. The sensor according to claim 11, wherein the absolute values of the angles γ and δ lie in the range of 30° to 70°.

21. The sensor according to claim 11, wherein the absolute values of the angles γ and δ lie in the range of 40° to 60°.

22. The sensor according to claim 11, wherein the size of the angles ε₁ and ε₂ being 5° to 15°.
